(19) United States
(12) Patent Application Publication
(10) Pub. No.: US 2016/0121274 A1
(43) Pub. Date: May 5, 2016

(54) METHOD AND DEVICE TO FOAM FOAMING LIQUIDS

(71) Applicant: Stefano LUNAZZI, Udine (IT)

(72) Inventor: Stefano LUNAZZI, UDINE (IT)

(21) Appl. No.: 14/889,313

(22) PCT Filed: May 9, 2014
(86) PCT No.: PCT/IB2014/061340

§ 371 Date: Nov. 5, 2015

(30) Foreign Application Priority Data
May 10, 2013 (IT) UD2013U000022

(51) Int. Cl. B01F 3/04; B01F 13/10; B01F 5/12

(52) U.S. Cl. CPC B01F 3/04453; B01F 5/12; B01F 13/1016; B01F 13/1022

(57) ABSTRACT

A method of foaming liquids containing foaming agents by means of a device having a feed line with an inlet and an outlet; a vibration pump located along the feed line; and a gas feed system for feeding gas into the feed line; the gas feed system being located upstream from the vibration pump; and the method including: feeding a liquid along the feed line; feeding gas into the feed line, upstream from the vibration pump, to form an emulsion of liquid and gas; feeding the emulsion to the vibration pump; and mixing the emulsion by means of the vibration pump to obtain a foam product.

### RELATED APPLICATION DATA

This application is the national stage entry of International Appl. No. PCT/IB2014/061340, filed May 9, 2014, which claims priority to Italian Patent Application No. UD2013U000022, filed May 10, 2013. All claims of priority to such patent application(s) are hereby made, and all such application(s) are hereby incorporated in their entirety by reference.

### TECHNICAL FIELD

The present invention relates to a method and device for foaming foamable liquids.

That is, the present invention relates to a method and device for producing foam from a liquid containing foaming agents and hereinafter referred to as a foamable liquid. It should be noted that the foamable liquid may be a solution of different liquids.

More specifically, the present invention relates to a method and device for producing and locally dispensing foam from a given foamable liquid. If the foamable liquid is cream, the device produces whipped cream; if the foamable liquid is milk, the device produces butter; if the foamable liquid is liquid soap/shampoo/hydrogen peroxide, the device produces foam detergent; if the liquid comprises oil, lemon juice and eggs, the device produces mayonnaise.

It should be noted that the term ‘foaming’ is intended to mean mixing and beating together a foamable liquid and gas to produce a foam.

### BACKGROUND ART

Machines are known which produce various amounts of foam (e.g. whipped cream, butter or similar) from a foamable liquid, but which are permanent fixtures installed in one place. So the relative product is produced locally, and must be dispensed or employed using other (normally hand-operated) devices. Despite producing large amounts of product, machines of this type have the drawback that the product must either be used straightaway or preserved for later use. More often than not, to be dispensed and/or used, the foam product must be inserted inside a dispenser, which obviously involves waste and time-consuming work to clean the necessary implements.

Foamable liquids are also known to be foamed using electric whips or beaters, but these are bulky and call for a certain amount of skill on the part of the user (e.g. whip position and speed) to obtain a properly foamed product. Using these devices, the quality of the foam product therefore depends strictly on the skill of the user.

### DISCLOSURE OF INVENTION

It is an object of the present invention to provide a method and device for producing and locally dispensing foam from a foamable liquid. The method and device according to the present invention are especially suitable for producing and dispensing whipped cream (e.g. for decorating cakes), or for producing shaving foam for immediate use, or for dispensing hair shampoo foam. The device according to the present invention may be used with any of various (edible or non-edible) foamable liquids.

A further object of the present invention is to provide a device designed to produce a foam product whose quality is independent of the skill of the user.

According to the present invention, there are provided a method and device for foaming foamable liquids, as claimed in the accompanying Claims.

### BRIEF DESCRIPTION OF THE DRAWINGS

A number of non-limiting embodiments of the present invention will be described by way of example with reference to the attached drawings, in which:

FIG. 1 shows a view in perspective of the device according to the present invention as a whole;

FIG. 2 shows a circuit diagram of the device according to the present invention;

FIG. 3 is similar to FIG. 2 and shows a first variation of the device according to the present invention;

FIG. 4 is similar to FIG. 3 and shows a second variation of the device according to the present invention;

FIG. 5 shows a third variation of the device according to the present invention;

FIG. 6 shows a fourth variation of the device according to the present invention.

### BEST MODE FOR CARRYING OUT THE INVENTION

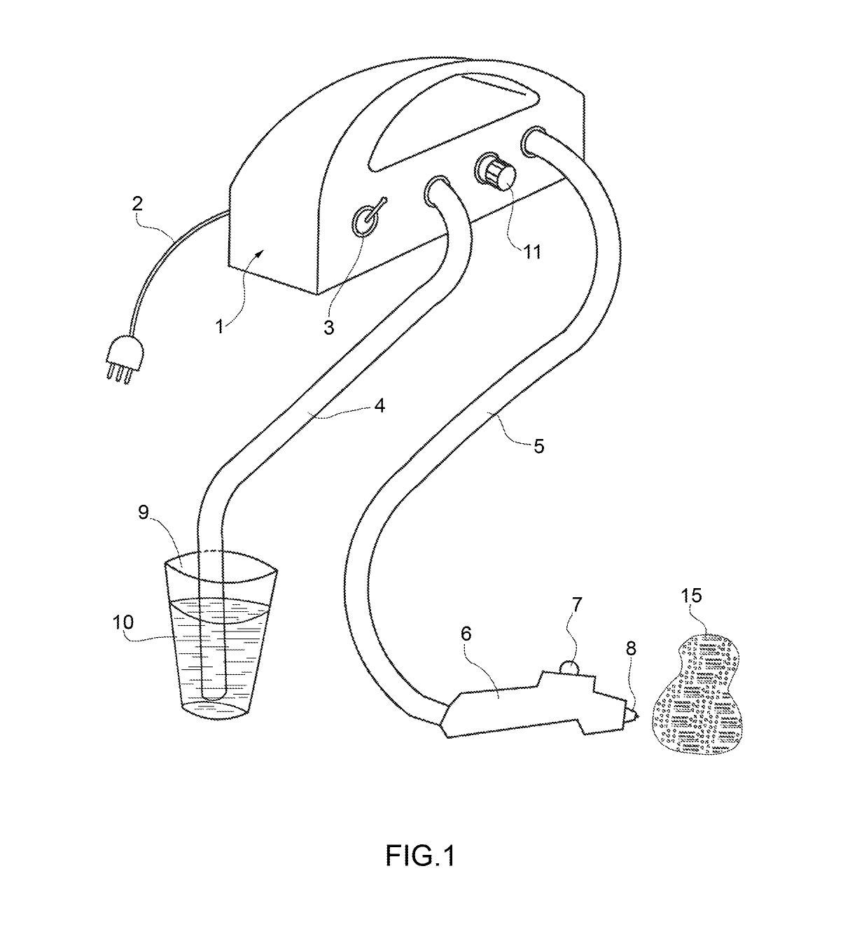

As shown in FIG. 1, the device 1 comprises an electric plug 2; a switch 3; and a tube 4 for drawing foamable liquid 10 from a container 9.

Device 1 also comprises an outlet tube 5 for foam 15; and a dispenser gun 6 located at the free end of outlet tube 5 and in turn comprising an outlet nozzle 8 and dispenser button 7.

Hereinafter, the terms ‘upstream’ and ‘downstream’ are used with reference to the flow direction of liquid 10.

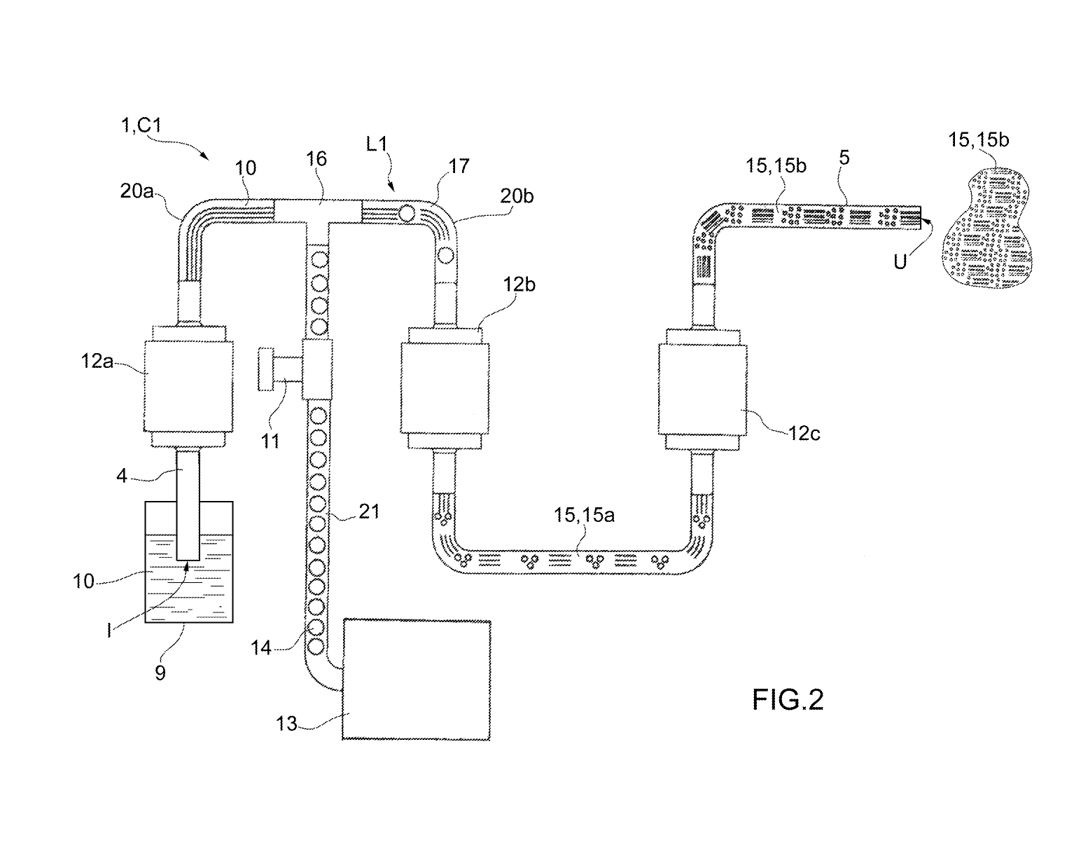

FIG. 2 shows a schematic of a circuit C1 of device 1, which comprises:
a foamable liquid feed line L1 having an inlet I and an outlet U;
a pump 12a located along feed line L1 to draw liquid 10 from container 9 by means of tube 4, which is connected to the inlet of pump 12a;
a vibration pump 12b located along feed line L1, downstream from pump 12a;
a connecting pipe 20 connecting pump 12a to vibration pump 12b;
a pump 13 for drawing in gas 14, in particular ambient air, to mix with foamable liquid 10;
a pipe 21 for gas 14, which connects pump 13 to pipe 20 by means of a fitting 16, which divides pipe 20 into an upstream portion 20a and downstream portion 20b with respect to fitting 16;
an adjusting knob 11 located along pipe 21 to adjust the flow of gas 14 to feed line L1;
a vibration pump 12c located along feed line L1;
a pipe 22 between and connecting vibration pump 12b and vibration pump 12c; and outlet tube 5 connected to the outlet of vibration pump 12c.

Pump 12a is also, for example, a vibration pump, but may obviously be any type of pump capable of feeding liquid 10 to feed line L1.

As shown in FIG. 2, vibration pumps 12b and 12c are series connected along feed line L1.

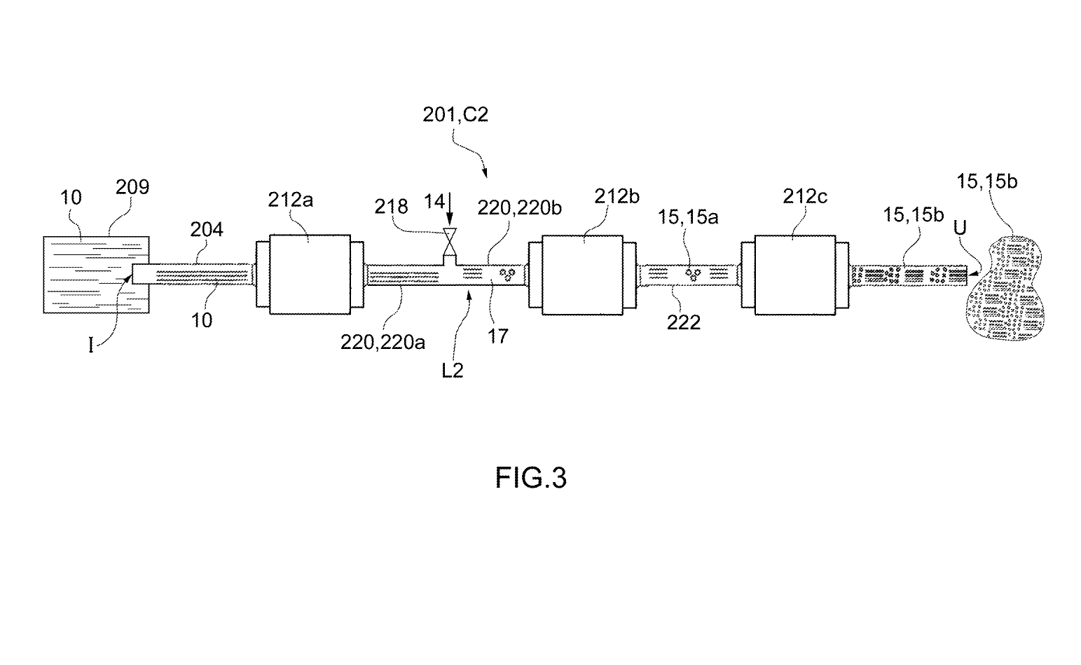

In the FIG. 3 variation, the device 201 comprises a circuit C2, in turn comprising a feed line L2, and a valve 218 (instead of pump 13 in circuit C1) for feeding gas 14 to feed line L2.

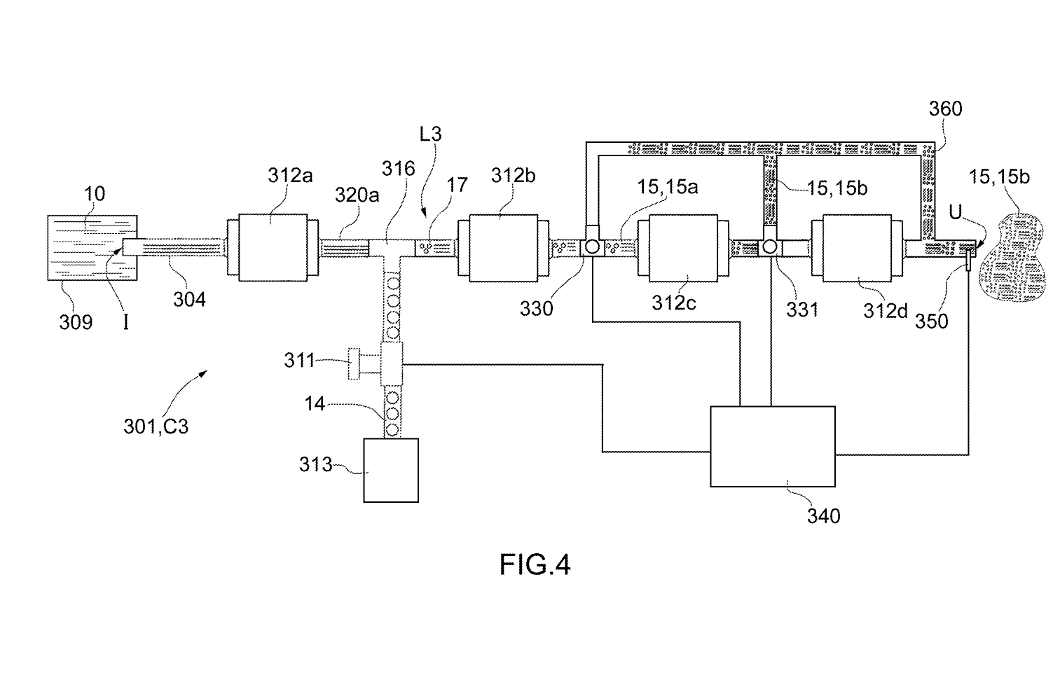

In the FIG. 4 variation, the device 301 comprises a circuit C3 with a feed line L3, which, in addition to the parts of device 1 in FIG. 2, also comprises:
a vibration pump 312d series connected along feed line L3, downstream from vibration pump 312c;
a pipe 323 between and connecting vibration pump 312c and vibration pump 312d;
a bypass pipe 360 which communicates with feed line L3 by a deflector valve 330 upstream from vibration pump 312c, and a deflector valve 331 upstream from vibration pump 312d;
a control sensor 350 located along outlet tube 305 to determine the stability of foam product 15; and
a control unit 340 connected (in known manner, shown schematically) to adjusting knob 311, each deflector valve 330, 331, and sensor 350.

Deflector valves 330 and 331, for example, are three-way valves. And control unit 340 may be manual or electric.

Depending on the type of liquid 10 for foaming, control unit 340 regulates the flow of gas 14 and the route of liquid 10 along circuit C3 (i.e. the number of vibration pumps through which to feed the liquid 10 and gas 14 emulsion). More specifically, control unit 340 activates each deflector valve 330, 331 to only bypass vibration pump 312d, or to bypass both vibration pumps 312c and 312d.

Control unit 340 may operate on the basis of input from the user operating knob 311, or on the basis of the findings of sensor 350 indicating the actual stability of foam product 15 with respect to a predetermined value.

FIG. 4 shows two vibration pumps bypassable by pipe 360, though a different number of vibration pumps (one or more than two) may obviously be bypassed.

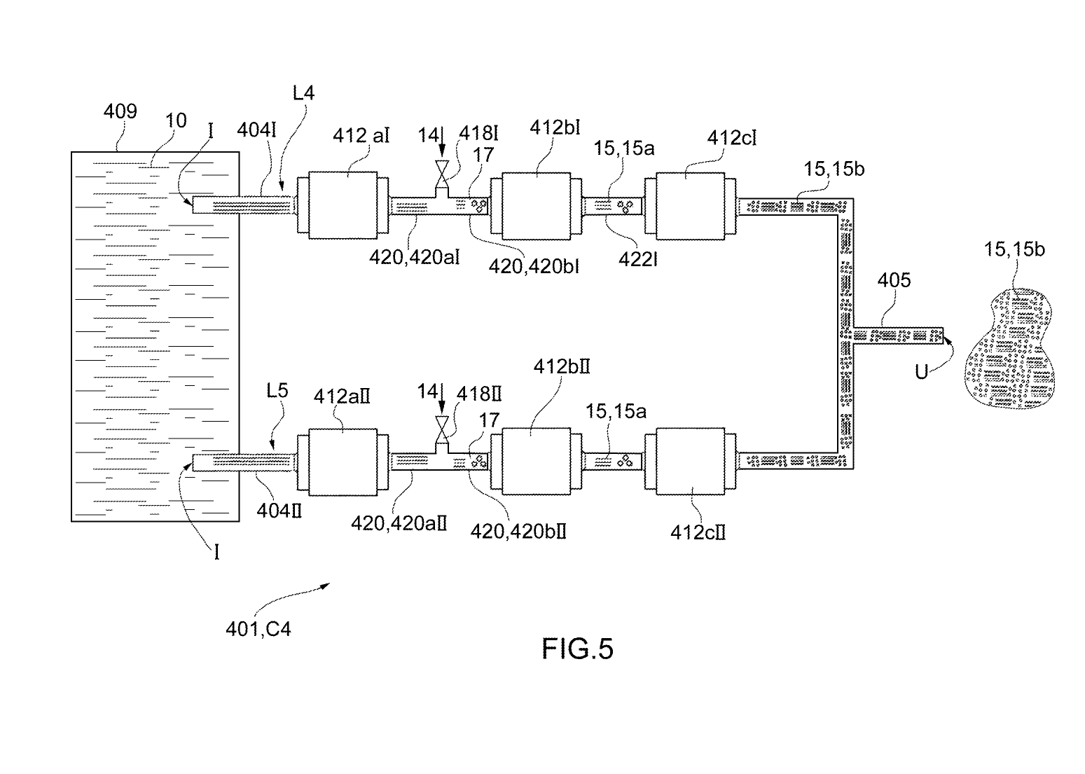

In the FIG. 5 variation, the device 401 comprises a circuit C4, in turn comprising two parallel feed lines L4, L5 with one outlet tube 405. Device 401 is especially suitable for producing large amounts of foam 15.

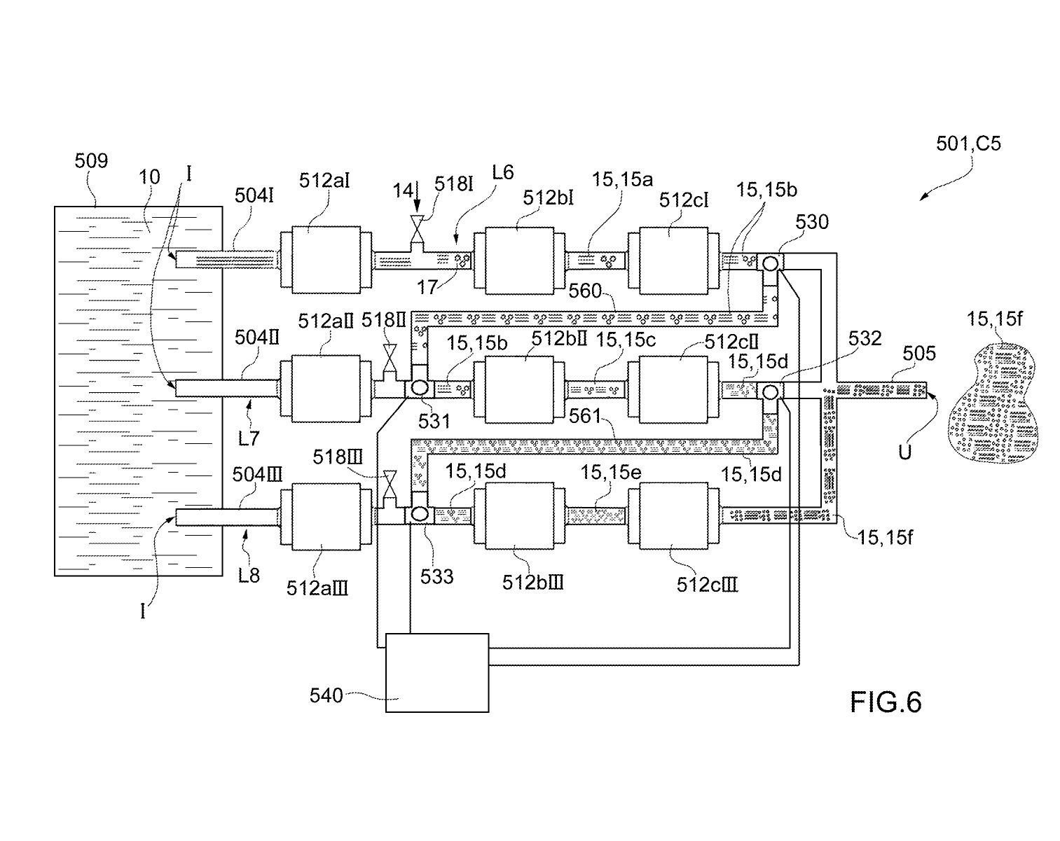

In the FIG. 6 variation, the device 501 comprises a circuit C5, in turn comprising three parallel feed lines L6, L7, L8 with one outlet tube 505. Device 501 is especially suitable for producing both large amounts of foam 15, and foams requiring greater processing, as explained clearly below.

More specifically, circuit C5 comprises:
a bypass line 560 which connects feed line L6, downstream from vibration pump 512cI, to feed line L7 upstream from vibration pump 512bII;
a bypass line 561 which connects feed line L7, downstream from vibration pump 512cII, to feed line L8 upstream from vibration pump 512bIII;
a deflector valve 530 interposed between feed line L6 and bypass line 560, downstream from vibration pump 512cI;
a deflector valve 531 interposed between bypass line 560 and feed line L7, upstream from vibration pump 512bII;
a deflector valve 532 interposed between feed line L7 and bypass line 561, downstream from vibration pump 512cII;
a deflector valve 533 interposed between bypass line 561 and feed line L8, upstream from vibration pump 512bIII;
a control unit 540 connected to each deflector valve 530, 531, 532, 533.

Deflector valves 530, 531, 532, 533 are preferably known three-way valves.

The control unit may be either electronic or manual.

FIG. 6 shows three parallel lines L6, L7, L8, though the number of lines may obviously differ.

Vibration pumps 12, 212, 312 and 412 are known types commonly used to pressurize liquid in coffee machines.

In another variation, not shown, devices 1, 201, 301, 401, 501 comprise a pressure switch located inside outlet tube 5 to open a known relief valve (not shown) and shut down vibration pumps 12, 212, 312, 412, 512 in the event dispenser gun 6 jams.

Devices 1, 201, 301, 401, 501 described are made of materials designed to ensure maximum hygiene and product quality, and which, in particular, are suitable for use in contact with food products.

Tubes 4, 204, 304, 404, 504 and 5, 205, 305, 405, 505 are preferably replaceable external tubes. And devices 1, 201, 301, 401, 501 can be supplied with gas 14 using any known type of gas feed system.

Devices 1, 201, 301, 401, 501 described may comprise a known cooling system (not shown) to prevent vibration pumps 12, 212, 312, 412, 512 from overheating. To produce foam product 15 from foamable liquid 10, device 1 operates as follows.

During operation of device 1, liquid 10 is drawn by pump 12a along tube 4. Pump 12a is a suction pump that forces liquid 10 into circuit C1 at a given pressure.

At the same time, pump 13 forces gas 14, in particular air, along pipe 21 to fitting 16.

At fitting 16, liquid 10 mixes with gas 14 to form an emulsion 17, which flows along portion 20b of pipe 20 to vibration pump 12b. Using knob 11, the user can adjust the flow of gas 14 into pipe 20 according to the type of liquid 10.

The emulsion 17 flowing through vibration pump 12b is beaten to form a foam product 15a in which the particles of foamable liquid and gas are smaller and mixed further with respect to emulsion 17.

Foam product 15a is then forced through vibration pump 12c, where it is beaten further to form a foam product 15b of a different stability from foam product 15a.

Finally, the end foam product 15b is expelled from dispenser gun 6. Using button 7 on dispenser gun 6, the user automatically activates device 1 to instantly produce foam product 15.

The type of end foam product 15 depends on the type of foamable liquid 10 fed into device 1. That is, cream will produce whipped cream; milk will produce butter; liquid soap will produce foam detergent; a solution of oil, eggs and lemon juice will produce mayonnaise; etc..

In the FIG. 4 variation, in addition to the above, the user indicates by means of knob 311 the type of liquid used, and control unit 340 accordingly determines whether or not to activate deflector valve 330 or 331. In this connection, it should be noted that operation of vibration pumps 312b, 312c and 312d is standard and cannot be altered, but the whipping time of foamable liquid 10 varies according to the type of foaming liquid 10, i.e. according to the foaming agent in liquid 10. To correctly whip each liquid 10 and possibly also to achieve a given stability of foam product 15, the user, by means of control unit 340, varies the number of vibration pumps 312 through which emulsion 17 is fed.

Alternatively, control unit 340 varies the number of vibration pumps 312 through which emulsion 17 is fed according to the stability of end foam product 15 detected by control sensor 350.

In the FIG. 4 variation, device 301 produces foam products 15 with three different stability levels (15a, 15b, 15c) from the same foamable liquid 10. Obviously, by varying the number of vibration pumps along feed line L3 and bypassed by bypass pipe 360, it is possible to obtain different respective stability levels of foam product 15.

In the FIG. 6 variation, the user, by means of control unit 540, may opt to operate all three feed lines L6, L7, L8 to produce a large amount of foam product 15, which is expelled from common outlet tube 505, or may opt to activate bypass pipe 560 and/or 561 to vary the number of series-connected vibration pumps 512 through which emulsion 17 is fed, to obtain a foam product 15 of a given stability.

In FIG. 6, both bypass pipes 560 and 561 are activated, so liquid 10 flows through six series-connected vibration pumps 512 to produce a foam product 15f. If only one of bypass pipes 560, 561 is activated, liquid 10 flows through four series-connected vibration pumps 512 to produce a foam product 15d. If both bypass pipes 560 and 561 are deactivated, liquid 10 only flows through two series-connected vibration pumps 512 to produce foam product 15b

Obviously, the number of vibration pumps 512 located along each feed line L, and the number of parallel feed lines L connected by bypass pipes may vary as required.

By means of control unit 340 or 540, the user therefore varies the number of vibration pumps 312 or 512 through which liquid 10 is fed according to the desired stability of end foam product 15.

Devices 1, 201, 301, 401, 501 are therefore substantially based on employing one or a number of series- or parallel-connected vibration pumps supplied with foamable liquid 10 and at least one source of gas 14.

As will be clear from the above description, vibration pumps 12, 212, 312, 412, 512 are extremely compact and so provide for obtaining highly compact, lightweight, and therefore easily portable devices 1, 201, 301, 401, 501.

Moreover, using devices 1, 201, 301, 401, 501, the quality of foam product 15 is independent of the skill of the user.

1) A method of foaming liquids (10) containing foaming agents by means of a device (1; 201; 301; 401; 501) comprising a feed line (L1; L2; L3; L4, L5; L6, L7, L8) having an inlet (I) and an outlet (U); a vibration pump (12b; 212b; 312b; 412bI, 412bII; 512bI, 512bII, 512bIII) located along the feed line (L1; L2; L3; L4; L5; L6, L7, L8); and a gas feed system (11, 13, 16, 21; 218; 311, 313, 316, 321; 418I, 418II; 518I, 518II, 518III); the method comprising the steps of:
feeding a foamable liquid (10) through the inlet (I) and along the feed line (L1; L2; L3; L4; L5);
feeding gas (14), by means of the gas feed system (11, 13, 16, 21; 218; 311, 313, 316, 321; 418I, 418II; 518I, 518II, 518III), into the feed line (L1; L2; L3; L4, L5; L6, L7, L8), upstream from the vibration pump (12b; 212b; 312b; 412bI, 412bII; 512bI, 512bII, 512bIII), to form inside the feed line (L1; L2; L3; L4; L5; L6, L7, L8) an emulsion (17) comprising liquid (10) and gas (14);
feeding the emulsion (17) to the vibration pump (12b; 212b; 312b; 412bI, 412bII; 512bI, 512bII, 512bIII);
mixing the emulsion (17) by means of the vibration pump (12b; 212b; 312b; 412bI, 412bII; 512bI, 512bII, 512bIII) to obtain a foam product (15, 15a).

2) A method as claimed in claim 1, wherein the device (1; 201; 301; 401; 501) comprises a number of vibration pumps (12b, 12c; 212b, 212c; 312b, 312c, 312d; 412b, 412c; 512b, 512c) series-connected along the feed line (L1; L2; L3; L4; L5; L6, L7, L8); and the step of mixing the emulsion (17) comprises feeding said emulsion (17) through a number of vibration pumps (12b, 12c; 212b, 212c; 312b, 312c, 312d; 412b, 412c) to obtain a foam product (15, 15b) with a different stability.

3) A method as claimed in claim 2, wherein the device (1; 201; 301; 401) comprises a bypass pipe (360); two or more vibration pumps (312b, 312c, 312d) series-connected along the feed line (L3); and a number of adjustable valves (330, 331) mounted to move from a first to a second work configuration and vice versa; wherein, in the second work configuration, each valve (330; 331) diverts the foam product (15; 15a, 15b, 15c) from the feed line (L3) to the bypass pipe (360); wherein each valve (330; 331) is installed along the feed line (L3), upstream from a respective vibration pump (312c; 312d); and wherein the mixing step comprises the sub-step of setting each valve (330; 331) to the first or second work configuration according to the type of liquid (10), so as to vary the number of vibration pumps (312b, 312c, 312d; 312b, 312c; 312b) through which the emulsion (317) is fed.

4) A device for foaming liquids (10) containing foaming agents, the device comprising a feed line (L1; L2; L3; L4, L5; L6, L7, L8) having an inlet (I) for liquids (10) and an outlet (U); a vibration pump (12b; 212b; 312b; 412bI, 412bII; 512bI, 512bII, 512bIII) located along said feed line (L1; L2; L3; L4, L5; L6, L7, L8); and a gas feed system (11, 13, 16, 21; 218; 311, 313, 316, 321; 418I, 418II; 518I, 518II, 518III) for feeding gas (14) into said feed line (L1; L2; L3; L4, L5; L6, L7, L8); and wherein the gas feed system (11, 13, 16, 21; 218; 311, 313, 316, 321; 418I, 418II; 518I, 518II, 518III) is located upstream from the vibration pump (12b; 212b; 312b; 412bI, 412bII; 512bI, 512bII, 512bIII).

5) A device as claimed in claim 4, and comprising a number of vibration pumps (12b; 212b; 312b; 412bI, 412bII; 512bI, 512bII, 512bIII) series-connected along the feed line (L1; L2; L3; L4, L5; L6, L7, L8).

6) A device as claimed in claim 5, and comprising a bypass pipe (360); and a number of adjustable valves (330,331), each installed along the feed line (L3), upstream from a respective vibration pump (312c, 312d); each valve (330; 331) is movable from a first to a second work configuration and vice versa; and each valve (330; 331), in the second work configuration, diverts the foam product (15; 15a, 15b, 15c) from the feed line (L3) to the bypass pipe (360).

7) A device as claimed in claim 6, wherein the device (301) comprises a control unit (340) connected to each valve (330, 331) and designed to set it to the first or second work configuration according to the type of liquid (10).

8) A device as claimed in claim 4, and comprising a number of parallel feed lines (L4, L5; L6, L7, L8); a number of vibration pumps (412bI, 412bII; 512bI, 512bII, 512bIII), each installed along a respective feed line (L4, L5; L6, L7, L8); and a number of gas feed systems (418I, 418II; 518I, 518II, 518III), each associated with a respective feed line (L4, L5; L6, L7, L8); the feed lines (L4, L5; L6, L7, L8) sharing a single outlet (U).

9) A device as claimed in claim 8, and comprising a bypass pipe (560; 561) which connects two feed lines (L6, L7; L7, L8) so as to arrange the vibration pumps (512bI, 512cI, 512bII, 512cII; 512bII, 512cII, 512bIII, 512cIII) of said feed lines (L6, L7; L7, L8) in series; the device (501) comprising an adjusting valve (530; 532) movable from a first to a second work configuration and vice versa; and the valve (530), in the second work configuration, diverts the foam product (15; 15b) from the feed line (L6; L7) to the bypass pipe (560; 561).

10) Use of a vibration pump (12b, 12c; 212b, 212c; 312b, 312c, 312d; 412b, 412c) to foam a liquid (10) containing foaming agents.
